(19) United States
(12) Patent Application Publication
(10) Pub. No.: US 2026/0202869 A1
(43) Pub. Date: Jul. 16, 2026

(54) LOW DROPOUT (LDO) VOLTAGE REGULATOR USING THIN-OXIDE FIELD EFFECT TRANSISTORS

(71) Applicant: QUALCOMM Incorporated, San Diego, CA (US)

(72) Inventor: Jiannan HUANG, San Diego, CA (US)

(21) Appl. No.: 19/016,736

(22) Filed: Jan. 10, 2025

(51) Int. Cl. G05F 1/569; G05F 3/26

(52) U.S. Cl. CPC G05F 1/569; G05F 3/262

(57) ABSTRACT

A low dropout (LDO) voltage regulator, including: a pass p-channel field effect transistor (PFET); a protection PFET coupled in series with the pass PFET; an operational amplifier including a first input configured to receive a reference voltage, and an output coupled to a gate of the pass PFET; a first switching device coupled between a drain of the pass PFET and a gate of the protection PFET; and a voltage generator coupled to the gate of the protection PFET.

### FIELD

This disclosure relates generally to low dropout voltage regulators, and in particular, to a low dropout (LDO) voltage regulator using thin-oxide field effect transistors (FETs) for circuit area reduction.

### BACKGROUND

A low dropout (LDO) voltage regulator is used to provide a regulated output voltage to many types of circuits, such as an oscillator which may be sensitive to the output voltage. An LDO voltage regulator typically includes a pass p-channel field effect transistor (PFET) coupled between an input to receive an input voltage Vin and an output where the output voltage Vout is produced. The pass PFET is typically implemented with a thick-oxide device to handle the relatively large voltage drop across it in sleep mode where the output voltage is at zero (0) Volt (e.g., Vin-0V). However, thick-oxide devices occupy significant circuit area, which may be undesirable, especially when large load current demands a very wide pass transistor.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a low dropout (LDO) voltage regulator. The LDO voltage regulator including: a pass p-channel field effect transistor (PFET); a protection PFET coupled in series with the pass PFET; an operational amplifier including a first input configured to receive a reference voltage, and an output coupled to a gate of the pass PFET; a first switching device coupled between a drain of the pass PFET and a gate of the protection PFET; and a voltage generator coupled to the gate of the protection PFET.

Another aspect of the disclosure relates to a method of operating a low dropout (LDO) voltage regulator including a pass p-channel field effect transistor (PFET) coupled in series with a protection PFET. The method including: in sleep mode of operation: directly or indirectly coupling a drain of the pass PFET to a gate of the protection PFET; and applying a voltage to the gate of the protection PFET, the voltage being between an upper voltage at an upper voltage rail and a lower voltage at a lower voltage rail; in active mode of operation: decoupling the drain of the pass PFET from the gate of the protection PFET; and turning on the protection PFET.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a schematic diagram of an example low dropout (LDO) voltage regulator in accordance with an aspect of the disclosure.

FIG. 2 illustrates a schematic diagram of another example low dropout (LDO) voltage regulator in accordance with another aspect of the disclosure.

FIG. 3A illustrates a schematic diagram of another example low dropout (LDO) voltage regulator in accordance with another aspect of the disclosure.

FIG. 3B illustrates a schematic diagram of the low dropout (LDO) voltage regulator of FIG. 3A in sleep mode in accordance with another aspect of the disclosure.

FIG. 3C illustrates a schematic diagram of the low dropout (LDO) voltage regulator of FIG. 3A in mission (active) mode in accordance with another aspect of the disclosure.

FIG. 4A illustrates a schematic diagram of another example low dropout (LDO) voltage regulator in accordance with another aspect of the disclosure.

FIG. 4B illustrates a schematic diagram of the low dropout (LDO) voltage regulator of FIG. 4A in sleep mode in accordance with another aspect of the disclosure.

FIG. 5 illustrates a schematic diagram of another example low dropout (LDO) voltage regulator in accordance with another aspect of the disclosure.

FIG. 6 illustrates a schematic diagram of another example low dropout (LDO) voltage regulator in accordance with another aspect of the disclosure.

FIG. 7 illustrates a flow diagram of an example method of operating a low dropout (LDO) voltage regulator in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. The term “substantially” means that the associated parameter may not be exact as indicated but accounts for some variation due to specified tolerances.

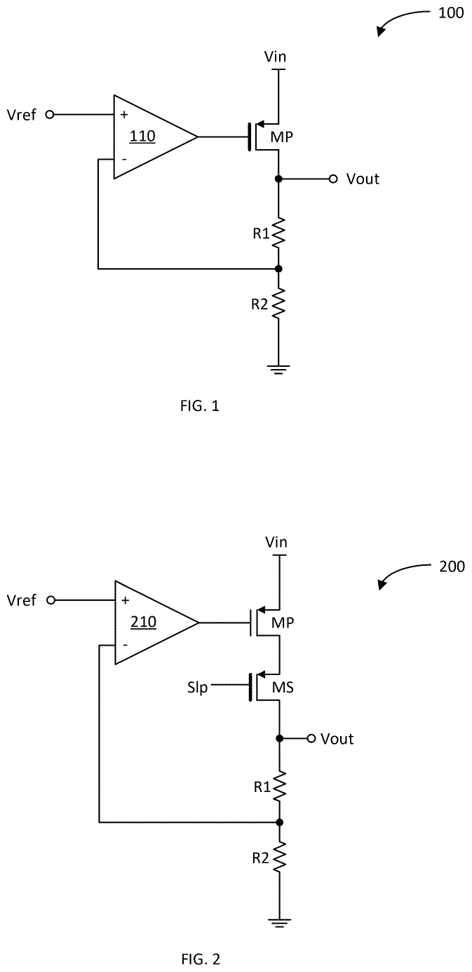

FIG. 1 illustrates a schematic diagram of an example low dropout (LDO) voltage regulator 100 in accordance with an aspect of the disclosure. The LDO voltage regulator 100 is configured to generate an output voltage Vout based on an input voltage Vin and a reference voltage Vref. The LDO voltage regulator 100 includes an operational amplifier 110, a p-channel field effect transistor (PFET) MP (often referred to as the pass PFET), and optionally resistors R1 and R2 serving as a voltage divider.

The operational amplifier 110 includes a first (e.g., positive) input configured to receive the reference voltage Vref, a second (e.g., negative) input, and an output. The pass PFET MP and resistors R1 and R2 are coupled in series between an upper voltage rail configured to receive the input voltage Vin and a lower voltage rail (e.g., ground). That is, the pass PFET MP includes a source coupled to the upper voltage rail (Vin), a gate coupled to the output of the operational amplifier 110, and a drain serving as an output of the LDO voltage regulator 100 where the output voltage Vout is produced. The first resistor R1 is coupled between the drain of the pass PFET MP and the second (e.g., negative) input of the operational amplifier 110. The second resistor R2 is coupled between the first resistor R1 and the lower voltage rail.

The relationship between the output voltage Vout, the input voltage Vin, and the reference voltage Vref may be given by the following:

$$Vout = ( 1 + R 1 / R 2 ) * Vref \qquad Eq . 1$$

As previously discussed, the resistors R1 and R2 may be optional. In such a case, the second (e.g., negative) input of the operational amplifier 110 is coupled to the output of the LDO voltage regulator 100. In such case, the output voltage Vout equals the reference voltage Vref.

In this example, the pass PFET MP is implemented as a thick-oxide PFET for reliability purpose. That is, the input voltage Vin may have a voltage level of 1.2 Volts (V). When the LDO voltage regulator 100 is turned off or in sleep mode, the output voltage Vout may be at zero (0) Volt. Accordingly, the voltage drop across the pass PFET MP is 1.2V. Therefore, in this example, the pass PFET MP is implemented with a thick-oxide to withstand the 1.2V voltage drop. Accordingly, the LDO voltage regulator 100 occupies a substantial circuit or integrated circuit (IC) area, where the pass PFET MP may occupy more than 70 percent of the total area of the LDO voltage regulator 100. It may be preferred to use a thin-oxide (core) device to reduce the circuit area of the LDO voltage regulator 100.

FIG. 2 illustrates a schematic diagram of another example low dropout (LDO) voltage regulator 200 in accordance with another aspect of the disclosure. The LDO voltage regulator 200 may be a solution to the thick-oxide requirement for a pass PFET. In particular, the LDO voltage regulator 200 includes an operational amplifier 210, a pass PFET MP, a protection PFET MS, and optional resistors R1 and R2. The LDO voltage regulator 200 is similar to the LDO voltage regulator 100 but further includes the protection PFET MS coupled between the pass PFET MP and the output of the LDO voltage regulator 200. That is, the protection PFET MS includes a source coupled to the drain of the pass PFET MP, a gate configured to receive a sleep mode (slp) signal, and a drain coupled to the output of the LDO voltage regulator 200.

In this example, the pass PFET MP may be implemented as a core (thin-oxide) device. For instance, when the sleep mode signal is not asserted (e.g., with a potential of zero (0)V), the protection FET MS turns on, and couple the drain of the pass PFET MP to the output of the LDO voltage regulator 200 (e.g., configures the LDO voltage regulator 200 similar to the LDO voltage regulator 100). When the sleep mode signal is asserted, the protection FET MS turns off, and the voltage at the drain of the pass PFET MP is substantially at Vin (e.g., 1.2V). Thus, the voltage drop across the pass PFET MP is substantially zero (0)V; and thus, the pass PFET MP may be implemented as a thin-oxide (core) device.

However, in sleep mode, the voltage across the protection PFET MS is now Vin (e.g., 1.2V). Thus, the protection PFET MS has to be implemented as a thick-oxide device. In essence, in this example, the thick-oxide requirement has been passed from the pass PFET MP to the protection PFET MS. However, as the protection PFET MS is serving as a switch, the protection MS need not be as large as the thick-oxide pass PFET MP of LDO voltage regulator 100. Therefore, the LDO voltage regulator 200 provides some circuit area reduction over the LDO voltage regulator 100. An LDO voltage regulator that uses only thin-oxide (core) devices would be more desirable for circuit area savings.

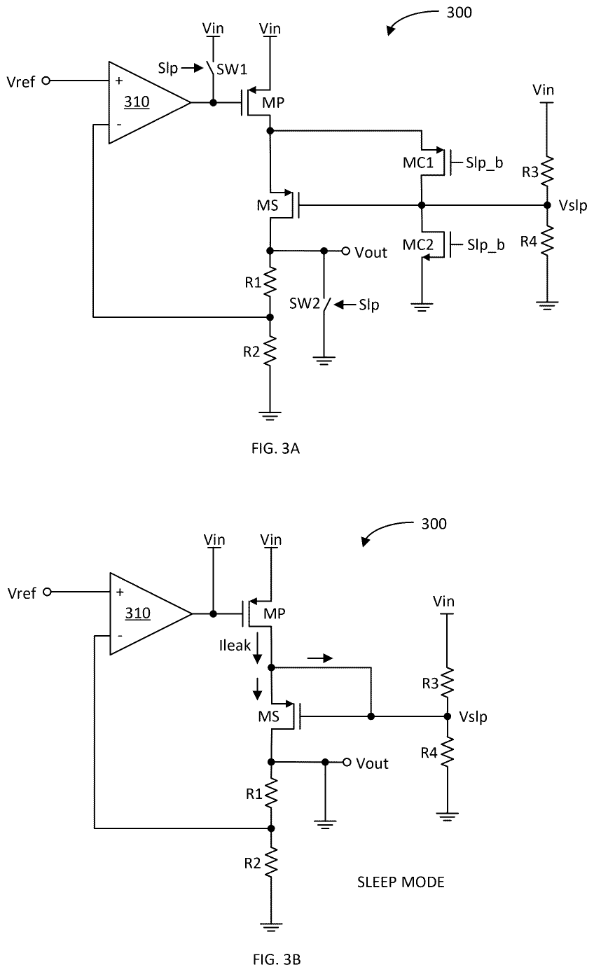

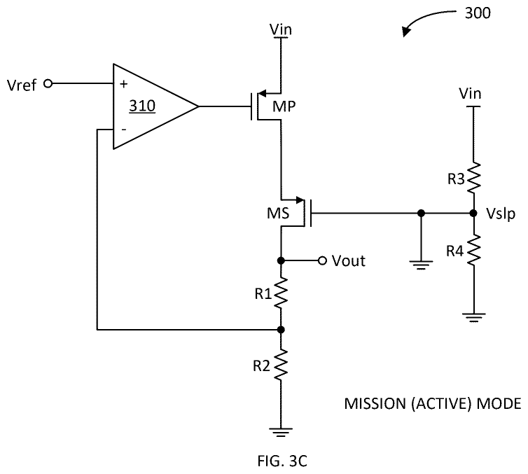

FIG. 3A illustrates a schematic diagram of another example low dropout (LDO) voltage regulator 300 in accordance with another aspect of the disclosure. The LDO voltage regulator 300 may be one that uses only thin-oxide devices for further circuit area reduction. That is, the pass PFET MP and the protection PFET MS may be both thin-oxide devices. The LDO voltage regulator 300 is similar to LDO voltage regulator 200, but further includes a first switching device SW1 (e.g., PFET), a second switching device SW2 (e.g., an n-channel field effect transistor (NFET)), a PFET MC1 (generally a switching device), NFET MC2 (generally a switching device), and a resistor ladder R3/R4 (generally a voltage generator).

The first switching device SW1 is coupled between the upper voltage rail (Vin) and the gate of the pass PFET MP, where the first switching device SW1 is responsive to a sleep mode (slp) signal. The second switching device SW2 is coupled between the output of the LDO voltage regulator 300 and the lower voltage rail (e.g., ground), where the second switching device SW2 is responsive to the sleep mode (slp) signal.

The PFET MC1 is coupled between the drain of the pass PFET MP and a gate of the protection FET MS. That is, the PFET MC1 includes a source coupled to the drain of the pass PFET MP, a gate configured to receive a complementary sleep mode (slp_b) signal, and a drain coupled to the gate of the protection PFET MS. The NFET MC2 is coupled between the gate of the protection PFET MS and the lower voltage rail. That is, the NFET MC2 includes a drain coupled to the gate of the protection PFET MS, a gate configured to receive the complementary sleep mode (slp_b) signal, and a source coupled to the lower voltage rail.

The resistor ladder R3/R4 is coupled between the upper voltage rail Vin and the lower voltage rail. The node between the resistors R3 and R4 is coupled to the gate of the protection PFET MS. The resistor ladder R3/R4 is configured to generate a voltage Vslp substantially mid-rail or half the input voltage Vin.

FIG. 3B illustrates an equivalent circuit of the LDO voltage regulator 300 in sleep mode. When the sleep mode (slp) signal is asserted (e.g., at Vin), the complementary sleep mode (slp_b) signal is at, for example, at 0V. The sleep mode (slp) signal turns on switching devices SW1 and SW2. The complementary sleep mode (slp_b) signal turns on PFET MC1 and turns off NFET MC2. In this configuration, the turned-on first switching device SW1 couples Vin to the gate of the pass PFET MP to turn it off. The turned-on second switching device SW2 couples the output of the LDO voltage regulator 300 to ground. The turned-on PFET MC1 couples the drain of the pass PFET MP to the gate of the protection PFET MS. And, the turned-off NFET MC2 isolates the ground from the gate of the protection PFET MS.

In this configuration, the mid-rail voltage Vslp generated by the resistor ladder R3/R4 is applied to the drain of the pass PFET MP and the gate of the protection PFET MS. Thus, the voltage drop across the pass PFET MP is Vin-Vslp (e.g., Vin/2=0.6V). And the voltage drop across the protection PFET MS is Vslp-0V (e.g., Vin/2=0.6V). Thus, the pass PFET MP and the protection PFET MS may be implemented as thin-oxide (core) devices without their respective voltage drops exceeding their reliability limit (e.g., 0.8V).

FIG. 3C illustrates an equivalent circuit of the low dropout (LDO) voltage regulator 300 in mission (active) mode. When the sleep mode (slp) signal is deasserted (e.g., 0V), the complementary sleep mode (slp_b) signal is at, for example, at Vin. The sleep mode (slp) signal turns off switching devices SW1 and SW2. The complementary sleep mode (slp_b) signal turns off PFET MC1 and turns on NFET MC2. In this configuration, the turned-off first switching device SW1 isolates Vin from the gate of the pass PFET MP allowing it to operate. The turned-off second switching device SW2 isolates the output of the LDO voltage regulator 300 from ground allowing the output voltage to be generated. The turned-off PFET MC1 isolates the drain of the pass PFET MP from the gate of the protection PFET MS. And, the turned-on NFET MC2 grounds the gate of the protection PFET MS to turn it on. Thus, the LDO voltage regulator 300 is configured to generate the output voltage Vout based on the reference voltage Vref and the input voltage Vin.

With reference again to FIG. 3B, one issue with the LDO voltage regulator 300 is that there may be some leakage current Ileak flowing through the pass PFET MP in sleep mode. Some of the leakage current flows through the protection PFET MS and some of the leakage current flows into the resistor ladder R3/R4. The leakage current flowing into the resistor ladder R3/R4 increases the voltage drop across the resistor R4; thereby, increasing the voltage Vslp close to Vin. Accordingly, the voltage drop across the protection PFET MS may exceed the reliability limit of the protection PFET MS. To address this, the resistance of the resistors R3 and R4 may be reduced to lower the voltage Vslp to, for example, the mid-rail voltage level. However, that results in more power consumption for the LDO voltage regulator 300.

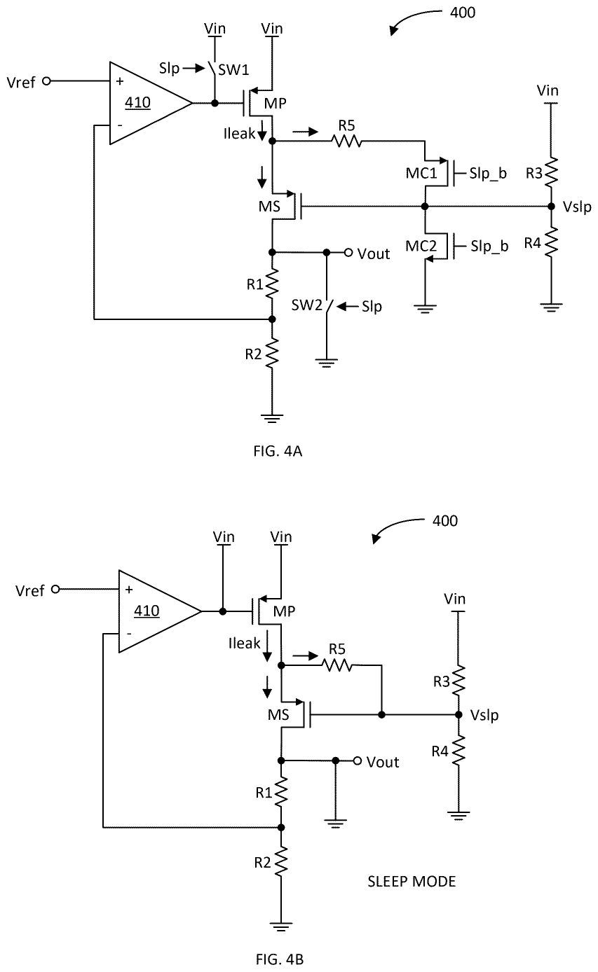

FIG. 4A illustrates a schematic diagram of another example low dropout (LDO) voltage regulator 400 in accordance with another aspect of the disclosure. The LDO voltage regulator 400 addresses the issue of the leakage current raising the voltage Vslp. The LDO voltage regulator 400 is similar to the LDO voltage regulator 300 but includes a resistor R5 coupled between the drain of the pass PFET MP and the gate of the protection PFET MS. In sleep mode (the equivalent circuit being depicted in FIG. 4B), the leakage current Ileak produces a voltage drop across the resistor R5. This also lowers the gate-to-source voltage Vgs of the protection PFET MS so it conducts more. This causes the leakage current through the protection PFET MS to increase and the leakage current flowing into the resistor ladder R3/R4 to reduce. This reduces the voltage drop across the protection PFET MS so that it is within its reliability limit.

FIG. 5 illustrates a schematic diagram of another example low dropout (LDO) voltage regulator 500 in accordance with another aspect of the disclosure. The LDO voltage regulator 500 is a variation of LDO voltage regulator 400. In particular, the LDO voltage regulator 500 includes a diode-connected PFET MD coupled between the drain of the pass PFET MP and the gate of the protection PFET MS. That is, the diode-connected PFET MD includes a source coupled to the drain of the pass PFET MP, and gate and drain coupled to the source of the PFET MC1. The diode-connected PFET MD produces a voltage drop across it due to the leakage current Ileak to reduce the gate-to-source Vgs voltage of the protection PFET MS. This causes the protection PFET MS to conduct more; thereby, increasing the leakage current through the protection PFET MS and decreasing the leakage current flowing into the resistor ladder R3-R4. This reduces the voltage drop across the protection PFET MS so that it is within its reliability limit.

An issue that may arise occurs when the LDO voltage regulator 400 is placed in mission (active) mode. The active mode involves the opening of the first switching device SW1 to enable the pass PFET MP, the opening of the second switching device SW2 so that the output voltage Vout can rise to its operational level, the turning off of PFET MC1 to decouple the path between the drain of the pass PFET MP and the gate of the protection PFET MS effectively remove the resistor R5 from the LDO voltage regulator 400, and the turning on of NFET MC2 ground the gate of the protection NFET MS so that it turns on.

When this initially occurs, the output voltage Vout is sitting at 0V, which is the output voltage Vout in sleep mode. The output voltage Vout takes some time to rise to its operational level. The protection PFET MS turns on almost immediately when the LDO voltage regulator 400 is placed in mission (active) mode. Accordingly, the drain voltage of the pass PFET MP becomes relatively small (e.g., 166 milliVolts (mV)). Thus, the drain-to-source voltage Vds of the pass PFET MP becomes large (e.g., 1.2V−0.166 mV=1.034), which exceeds it reliability limit of 0.8V. The following describes a solution to this issue.

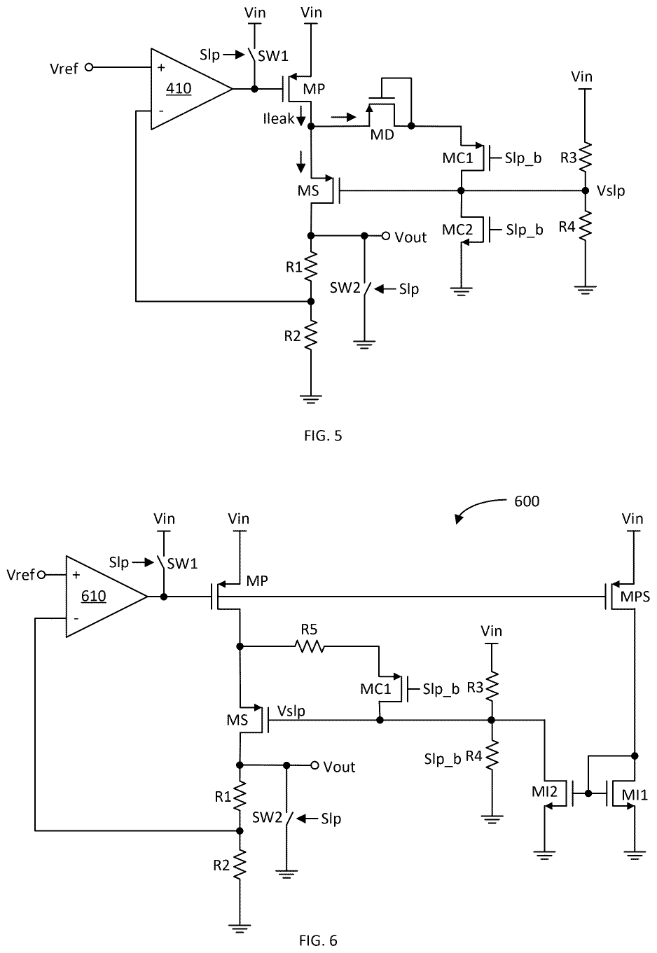

FIG. 6 illustrates a schematic diagram of another example low dropout (LDO) voltage regulator 600 in accordance with another aspect of the disclosure. The LDO voltage regulator 600 provides circuitry for slowing down the turning on of the protection PFET MS based on the current flowing through the pass PFET MP. This is done to prevent the source-to-drain voltage Vds of the pass PFET MP from exceeding its reliability limit.

The LDO voltage regulator 600 is similar to LDO voltage regulator 400 with a few exceptions. First, the NFET MC2 is not present in the LDO voltage regulator 600 so that the protection PFET MS does not turn on immediately upon entering the mission mode. The LDO voltage regulator 600 further includes current mirrors for sensing the current through the pass PFET MP and turning on the protection PFET MS based on the sensed current. In this regard, the LDO voltage regulator 600 further includes PFET MPS and NFETs MI1 and MI2.

The PFET MPS includes a source coupled to the upper voltage rail Vin, a gate coupled to the gate of the pass PFET MP, and a drain coupled to the drain and gate of diode-connected NFET MI1 and the gate of NFET MI2. The NFET MI1 and NFET MI2 include respective sources coupled to the lower voltage rail (e.g., ground). The NFET MI2 includes a drain coupled to the gate of the protection PFET MS.

In operation, when the LDO voltage regulator 600 is initially placed in mission (active) mode, the current flowing through the pass PFET MP begins to increase. Because of the current mirror relationship between the pass PFET MP and the PFET MPS, a proportional or related current is generated through the PFET MPS and the diode-connected NFET MI1. Also because of the current mirror relationship between the NFET MI1 and the NFET MI2, a proportional or related current is generated through the NFET MI2. The current flowing through the NFET MI2 pulls down the voltage Vslp to substantially proportional or related to the current through the NFET MI2. Accordingly, the protection PFET MS is turned on based on the current flowing through the pass PFET MP. As discussed, this gradually reduces the drain voltage of the pass PFET MP so as to prevent its reliability limit from being exceeded.

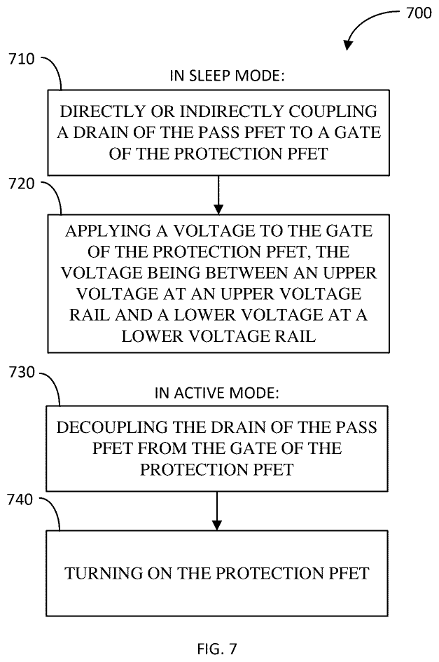

FIG. 7 illustrates a flow diagram of an example method 700 of operating a low dropout (LDO) voltage regulator including a pass PFET coupled in series with a protection PFET in accordance with another aspect of the disclosure. The method 700 includes: in sleep mode of operation: directly or indirectly coupling a drain of the pass PFET to a gate of the protection PFET (block 710); and applying a voltage to the gate of the protection PFET (block 720). An example of a means for directly or indirectly coupling a drain of the pass PFET to a gate of the protection PFET includes the switching device PFET MC1. An example of means for applying a voltage to a gate of the pass PFET includes the resistor ladder R3/R4.

The method 700 further includes: in active mode of operation, decoupling the drain of the pass PFET from the gate of the protection PFET (block 730); and turning on the protection PFET (block 740). An example of a means for decoupling the drain of the pass PFET from the gate of the protection PFET includes the switching device PFET MC1. An example of a means for turning on the protection PFET includes any one of PFET MC2 or the current mirror NFET MI2.

The following provides an overview of aspects of the present disclosure:
Aspect 1: A low dropout (LDO) voltage regulator, comprising: a pass p-channel field effect transistor (PFET); a protection PFET coupled in series with the pass PFET; an operational amplifier including a first input configured to receive a reference voltage, and an output coupled to a gate of the pass PFET; a first switching device coupled between a drain of the pass PFET and a gate of the protection PFET; and a voltage generator coupled to the gate of the protection PFET.
Aspect 2: The LDO voltage regulator of aspect 1, wherein the voltage generator comprises a resistor ladder including a first resistor and a second resistor coupled between an upper voltage rail and a lower voltage rail, wherein a node between the first resistor and the second resistor is coupled to the gate of the protection PFET.
Aspect 3: The LDO voltage regulator of aspect 1 or 2, wherein the first switching device comprises a PFET including a gate configured to receive a complementary sleep mode signal.
Aspect 4: The LDO voltage regulator of any one of aspects 1-3, further comprising a second switching device coupled between the gate of the protection PFET and a lower voltage rail.
Aspect 5: The LDO voltage regulator of aspect 4, wherein the second switching device comprises an n-channel field effect transistor (NFET) including a gate configured to receive a complementary sleep mode signal.
Aspect 6: The LDO voltage regulator of any one of aspects 1-5, further comprising a voltage drop device coupled between the drain of the pass PFET and the first switching device.
Aspect 7: The LDO voltage regulator of aspect 6, wherein the voltage drop device comprises a resistor.
Aspect 8: The LDO voltage regulator of aspect 6 or 7, wherein the voltage drop device comprises a diode-connected PFET.
Aspect 9: The LDO voltage regulator of any one of aspects 1-3 and 6-8, further comprising: a first current mirror including a PFET having a gate coupled to a gate of the pass PFET, and a second current mirror including a diode-connected NFET coupled in series with the PFET, and an NFET including a gate coupled to the diode-connected NFET and a drain coupled to the gate of the protection PFET.
Aspect 10: The LDO voltage regulator of any one of aspects 1-9, further comprising a second switching device coupled between the upper voltage rail and the gate of the pass PFET, wherein the second switching device is configured to receive a sleep mode signal.
Aspect 11: The LDO voltage regulator of any one of aspects 1-10, wherein the operational amplifier includes a second input coupled to a drain of the protection PFET.
Aspect 12: The LDO voltage regulator of any one of aspects 1-10, further comprising a first resistor and a second resistor coupled in series between a drain of the protection PFET and the lower voltage rail, wherein the operational amplifier includes a second input coupled to a node between the first resistor and the second resistor.
Aspect 13: The LDO voltage regulator of any one of aspects 1-12, further comprising a second switching device coupled between a drain of the protection PFET and a lower voltage rail.
Aspect 14: A method of operating a low dropout (LDO) voltage regulator including a pass p-channel field effect transistor (PFET) coupled in series with a protection PFET, comprising: in sleep mode of operation: directly or indirectly coupling a drain of the pass PFET to a gate of the protection PFET; and applying a voltage to the gate of the protection PFET, the voltage being between an upper voltage at an upper voltage rail and a lower voltage at a lower voltage rail; in active mode of operation: decoupling the drain of the pass PFET from the gate of the protection PFET; and turning on the protection PFET.
Aspect 15: The method of aspect 14, wherein coupling the drain of the pass PFET to the gate of the protection PFET comprises coupling the drain of the pass PFET to the gate of the protection PFET via a voltage drop device.
Aspect 16: The method of aspect 15, wherein the voltage drop device comprises a resistor.
Aspect 17: The method of aspect 15 or 16, wherein the voltage drop device comprises a diode-connected PFET.
Aspect 18: The method of any one of aspects 15-17, wherein turning on the protection PFET comprises turning on the protection PFET based on a current through the pass PFET.
Aspect 19: The method of aspect 18, wherein turning on the protection PFET comprises lowering the voltage at the gate of the protection PFET based on the current through the pass PFET.
Aspect 20: The method of any one of aspects 14-19, further comprising: in the active mode of operation, controlling a voltage at a gate of the pass PFET based on a reference voltage and an output voltage of the LDO voltage regulator.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. A low dropout (LDO) voltage regulator, comprising:
a pass p-channel field effect transistor (PFET);
a protection PFET coupled in series with the pass PFET;
an operational amplifier including a first input configured to receive a reference voltage, and an output coupled to a gate of the pass PFET;
a first switching device coupled between a drain of the pass PFET and a gate of the protection PFET; and
a voltage generator coupled to the gate of the protection PFET.

2. The LDO voltage regulator of claim 1, wherein the voltage generator comprises a resistor ladder including a first resistor and a second resistor coupled between an upper voltage rail and a lower voltage rail, wherein a node between the first resistor and the second resistor is coupled to the gate of the protection PFET.

3. The LDO voltage regulator of claim 1, wherein the first switching device comprises a PFET including a gate configured to receive a complementary sleep mode signal.

4. The LDO voltage regulator of claim 1, further comprising a second switching device coupled between the gate of the protection PFET and a lower voltage rail.

5. The LDO voltage regulator of claim 4, wherein the second switching device comprises an n-channel field effect transistor (NFET) including a gate configured to receive a complementary sleep mode signal.

6. The LDO voltage regulator of claim 1, further comprising a voltage drop device coupled between the drain of the pass PFET and the first switching device.

7. The LDO voltage regulator of claim 6, wherein the voltage drop device comprises a resistor.

8. The LDO voltage regulator of claim 6, wherein the voltage drop device comprises a diode-connected PFET.

9. The LDO voltage regulator of claim 1, further comprising:
a first current mirror including a PFET having a gate coupled to a gate of the pass PFET; and
a second current mirror including a diode-connected NFET coupled in series with the PFET, and an NFET including a gate coupled to the diode-connected NFET and a drain coupled to the gate of the protection PFET.

10. The LDO voltage regulator of claim 1, further comprising a second switching device coupled between the upper voltage rail and the gate of the pass PFET, wherein the second switching device is configured to receive a sleep mode signal.

11. The LDO voltage regulator of claim 1, wherein the operational amplifier includes a second input coupled to a drain of the protection PFET.

12. The LDO voltage regulator of claim 1, further comprising a first resistor and a second resistor coupled in series between a drain of the protection PFET and a lower voltage rail, wherein the operational amplifier includes a second input coupled to a node between the first resistor and the second resistor.

13. The LDO voltage regulator of claim 1, further comprising a second switching device coupled between a drain of the protection PFET and a lower voltage rail.

14. A method of operating a low dropout (LDO) voltage regulator including a pass p-channel field effect transistor (PFET) coupled in series with a protection PFET, comprising:
in sleep mode of operation:
directly or indirectly coupling a drain of the pass PFET to a gate of the protection PFET; and
applying a voltage to the gate of the protection PFET, the voltage being between an upper voltage at an upper voltage rail and a lower voltage at a lower voltage rail;
in active mode of operation:
decoupling the drain of the pass PFET from the gate of the protection PFET; and
turning on the protection PFET.

15. The method of claim 14, wherein indirectly coupling the drain of the pass PFET to the gate of the protection PFET comprises indirectly coupling the drain of the pass PFET to the gate of the protection PFET via a voltage drop device.

16. The method of claim 15, wherein the voltage drop device comprises a resistor.

17. The method of claim 15, wherein the voltage drop device comprises a diode-connected PFET.

18. The method of claim 14, wherein turning on the protection PFET comprises turning on the protection PFET based on a current through the pass PFET.

19. The method of claim 14, wherein turning on the protection PFET comprises lowering the voltage at the gate of the protection PFET based on the current through the pass PFET.

20. The method of claim 14, further comprising: in the active mode of operation, controlling a voltage at a gate of the pass PFET based on a reference voltage and an output voltage of the LDO voltage regulator.
